(19) United States
(12) Patent Application Publication
(10) Pub. No.: US 2024/0103891 A1
(43) Pub. Date: Mar. 28, 2024

(54) INFORMATION PROCESSING APPARATUS, NON-TRANSITORY COMPUTER READABLE MEDIUM, AND METHOD FOR PROCESSING INFORMATION

(71) Applicant: FUJIFILM Business Innovation Corp., Tokyo (JP)

(72) Inventors: Yuki Minamisako, Kanagawa (JP); Nobumi Kusano, Kanagawa (JP); Katsutoshi Sakaguchi, Kanagawa (JP)

(73) Assignee: FUJIFILM Business Innovation Corp., Tokyo (JP)

(21) Appl. No.: 18/180,280

(22) Filed: Mar. 8, 2023

(30) Foreign Application Priority Data
Sep. 26, 2022 (JP) 2022-152114

(51) Int. Cl. G06F 9/451; G06F 3/04883

(52) U.S. Cl. CPC G06F 9/453; G06F 3/04883; G06F 2203/04101

(57) ABSTRACT

An information processing apparatus includes a processor configured to: detect a specific noncontact state established by a user for an operation surface; and present, if the specific contact state is detected, an explanation of an operation method used for the operation surface or a function of an object displayed on the operation surface.

### CROSS-REFERENCE TO RELATED APPLICATIONS

This application is based on and claims priority under 35 USC 119 from Japanese Patent Application No. 2022-152114 filed Sep. 26, 2022.

### BACKGROUND

### (i) Technical Field

The present disclosure relates to an information processing apparatus, a non-transitory computer readable medium, and a method for processing information.

### (ii) Related Art

An information processing apparatus with which a noncontact operation, which is an operation performed on an operation surface without an operation medium, such as a finger or a stylus, coming into direct contact with the operation surface, can be performed has been proposed.

Japanese Unexamined Patent Application Publication No. 2014-241033, for example, discloses an input processing apparatus including an input detection unit that detects proximity and contact of an object as an input, an event type determination unit that determines a type of input event on the basis of coordinates of the detected input, a mode information obtaining unit that obtains information regarding a processing mode for an application, and a transmission unit that transmits data including the type of input event and the obtained processing mode to an information processing apparatus.

Japanese Unexamined Patent Application Publication No. 2011-134111 discloses a technique for performing an arithmetic operation for estimating area of contact of a finger or the like on a touch screen, determining whether the finger or the like has come into contact with or in proximity to the touch screen, and, in the case of contact, enlarging an image in accordance with the area of contact.

Japanese Unexamined Patent Application Publication No. 2010-205050 discloses a user interface (UI) apparatus including a proximity/contact determination unit that detects a proximity or contact state of an object with respect to a touch panel, a coordinate detection unit that, if the proximity or contact state is detected, detects relative proximity or contact position coordinates of the object with respect to the touch panel, an approach velocity calculation unit that calculates velocity of an object approaching to the touch panel on the basis of temporal changes in the proximity position coordinates, and a content control unit that controls information displayed on a screen of a display unit in accordance with the contact position coordinates and the approach velocity.

### SUMMARY

Users of apparatuses equipped with a contact-type or noncontact-type UI, however, sometimes find it difficult to understand types of processing and operations available in the apparatuses.

When a contact-type or noncontact-type UI is used, inputs are usually made through gesture operations. If a user knows how to perform gesture operations, the user can operate an apparatus intuitively and easily. If a user does not know available gesture operations, on the other hand, the user might not be able to use provided functions at will.

It has thus been difficult to make a user precisely understand information regarding functions and operations of an apparatus when a noncontact-type UI has detected that the user does not know the functions and the operations.

Aspects of non-limiting embodiments of the present disclosure relate to providing: an information processing apparatus and a method (for processing information) that, when a noncontact-type UI detects states in which a user is not aware of apparatus functions and operations, present the detected states as guide information; and a non-transitory computer readable medium used therefor.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to detect: a specific noncontact state established by a user for an operation surface; and present, if the specific contact state is detected, an explanation of an operation method used for the operation surface or a function of an object displayed on the operation surface.

### BRIEF DESCRIPTION OF THE DRAWINGS

An exemplary embodiment of the present disclosure will be described in detail based on the following figures, wherein:

FIG. 1 is a schematic diagram illustrating the configuration of an information processing apparatus according to an exemplary embodiment;

FIG. 2 is a diagram illustrating a space in front of an operation surface and an operation performed on the operation surface;

FIG. 3 is another diagram illustrating the space in front of the operation surface and the operation performed on the operation surface;

FIG. 4 is a flowchart illustrating a method for processing information according to the exemplary embodiment;

FIG. 5 is a diagram illustrating an example of a menu screen displayed on the operation surface;

FIG. 6 is a diagram illustrating an example of a menu screen where guide information is displayed;

FIG. 7 is a diagram illustrating an example of a menu screen partially covered by a proximity detection area;

FIG. 8 is a diagram illustrating an example of a menu screen where the guide information is displayed outside the proximity detection area;

FIG. 9 is a diagram illustrating another example of the menu screen where the guide information is displayed outside the proximity detection area;

FIG. 10 is a diagram illustrating an example of a menu screen where tip buttons are displayed;

FIG. 11 is a diagram illustrating an example of a menu screen where guide information corresponding to one of the tip buttons is displayed;

FIG. 12 is a diagram illustrating an example of a specific noncontact state that is not valid as a gesture operation;

FIG. 13 is a diagram illustrating an example of a menu screen where guide information is displayed in accordance with the specific noncontact state that is not valid as a gesture operation;

FIG. 14 is a diagram illustrating another example of the specific noncontact state that is not valid as a gesture operation;

FIG. 15 is a diagram illustrating another example of the menu screen where guide information is displayed in accordance with the specific noncontact state that is not valid as a gesture operation;

FIG. 16 is a diagram illustrating an example of the specific noncontact state that is not valid as a gesture operation;

FIG. 17 is a diagram illustrating an example where guide information is displayed as an animation in accordance with the specific noncontact state that is not valid as a gesture operation; and

FIG. 18 is a diagram illustrating another example where guide information is displayed as an animation in accordance with the specific noncontact state that is not valid as a gesture operation.

### DETAILED DESCRIPTION

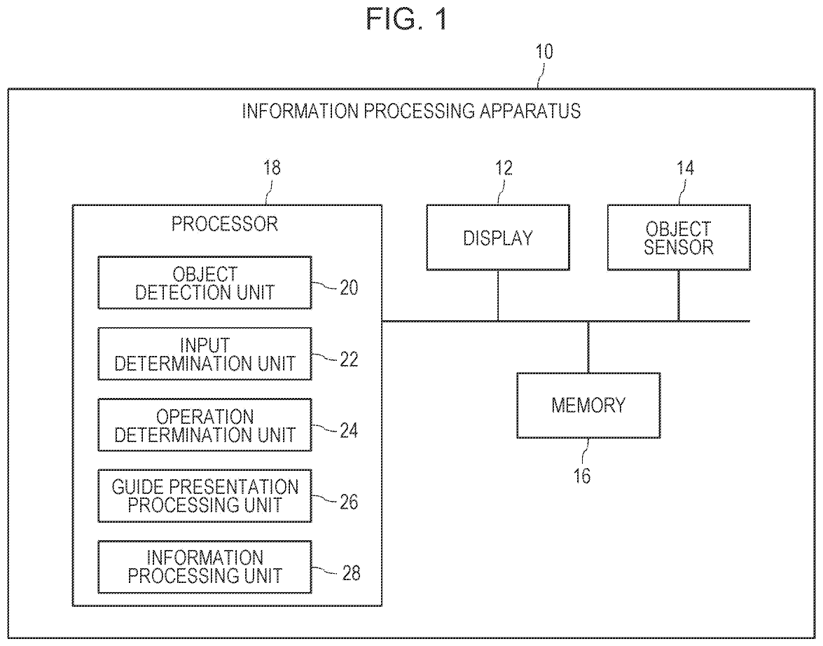

FIG. 1 is a schematic diagram illustrating the configuration of an information processing apparatus 10 according to an exemplary embodiment. As described in detail later, the information processing apparatus 10 includes a UI with which noncontact operations can be performed. A noncontact operation refers to an operation performed on an operation surface using an operation medium without the operation medium coming into direct contact with the operation surface. A noncontact operation is also called a “hover operation”. A contact operation refers to an operation performed on an operation surface using an operation medium with the operation medium coming into direct contact with the operation surface. An operation medium is a medium for performing an operation, and may be, for example, a user's finger or a stylus.

In the present exemplary embodiment, the information processing apparatus 10 is a multifunction device that has a printing function, a copying function, a scanning function, and the like and that performs printing, copying, scanning, or the like in accordance with a processing command (job) from the user, but the information processing apparatus 10 is not limited to this, and the information processing apparatus 10 may be any device with which noncontact operations can be performed.

As illustrated in FIG. 1, the information processing apparatus 10 includes a display 12, an object sensor 14, a memory 16, and a processor 18. Although not illustrated, the information processing apparatus 10 may also include a communication interface (e.g., a network interface card (NIC)) for communicating with other devices over a communication network such as a local area network (LAN) or a wide area network (WAN) and a processing device that performs printing or scanning (e.g., a printer or a scanner).

The display 12 is a display unit for displaying operation screens. The display 12 includes, for example, a liquid crystal panel or an organic electroluminescent (EL) panel. The processor 18 displays various screens on the display 12. For example, the display 12 displays an operation screen including objects to be subjected to a noncontact operation or a contact operation. The objects include operation icons and various buttons to be used by the user.

The object sensor 14 is a detection unit that detects approach or contact of an object. The object sensor 14 detects an object in contact with or close proximity to a display surface of the display 12. More specifically, the object sensor 14 detects presence or absence of an object in close proximity to or contact with the display 12 and a position of the object. A position of an object includes a position of the object on a plane parallel to the display 12 and a position of the object in a direction perpendicular to the display 12. The object sensor 14 detects not only an operation medium for performing noncontact operations and contact operations on the display 12 but also any object approaching the display 12.

In the present exemplary embodiment, the display surface of the display 12 corresponds to the operation surface to be subjected to operations. That is, an operation screen including operation icons and various buttons to be used by the user are displayed in a part or the entirety of the operation surface. In the following description, the operation surface will be simply referred to as the “display 12”.

One of various known methods for detecting an object may be employed. For example, the object sensor 14 may be a capacitive sensor that detects changes in capacitance between the display 12 and an object. In this case, the processor 18 can detect presence or absence of an object detected by the object sensor 14 and a position of the object in accordance with changes in capacitance between the display 12 and the object. Alternatively, the object sensor 14 may be an optical sensor that detects light. In this case, a light source, which is not illustrated, emits infrared light or laser light onto the display surface of the display 12, and the object sensor 14 detects reflected light, especially light reflected from the object. The processor 18 can detect presence or absence of an object and a position of the object on the basis of the reflected light detected by the object sensor 14. By providing the object sensor 14 over the display 12, an object in close proximity to or contact with the display 12 can be detected.

The object sensor 14 transmits, to the processor 18, a detection signal indicating detection of an object and a position of the detected object.

The memory 16 includes a hard disk drive (HDD), a solid-state drive (SSD), an embedded MultiMediaCard (eMMC), a read-only memory (ROM), a random-access memory (RAM), or the like. The memory 16 stores a program for processing information, which is used to operate the components of the information processing apparatus 10. The program for processing information may be stored in a non-transitory computer readable medium, instead, such as a universal serial bus (USB) memory or a compact disc read-only memory (CD-ROM). The information processing apparatus 10 can read the program for processing information from the storage medium and execute the program.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed. As illustrated in FIG. 1, the processor 18 achieves functions of an object detection unit 20, an input determination unit 22, an operation determination unit 24, a guide presentation processing unit 26, and an information processing unit 28 in accordance with the program for processing information stored in the memory 16.

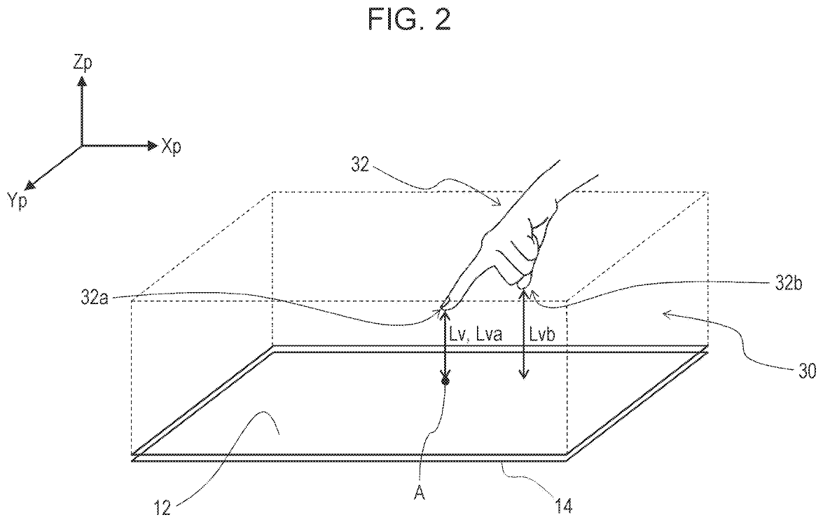

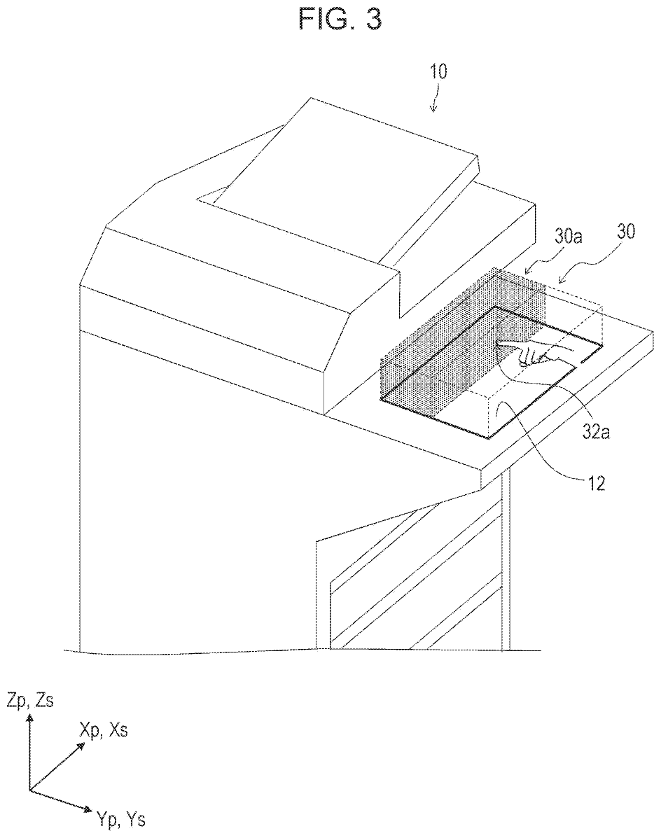

The object detection unit 20 detects an object inside a space in front of the display 12 on the basis of a detection signal from the object sensor 14. A process performed by the object detection unit 20 will be specifically described with reference to FIGS. 2 and 3. FIGS. 2 and 3 illustrate a space 30 in front of the display 12 and an operation medium 32 at least partially located inside the space 30. A direction parallel to the display 12 (a lateral direction of the display 12) is defined as an Xp-axis, a direction parallel to the display 12 and perpendicular to the Xp-axis (a longitudinal direction of the display 12) is defined as a Yp-axis, and a direction perpendicular to the display 12 is defined as a Zp-axis.

The space 30 in front of the display 12 is an area through which the display 12 passes when the display 12 is translated in a positive direction of the Zp-axis and an area within a certain distance from the display 12 in a Zp-axis direction. The certain distance, that is, the length of the space 30 in the Zp-axis direction, is determined in accordance with a detectable range of the object sensor 14. That is, the certain distance may be a distance within which the object sensor 14 can detect an object.

As illustrated in FIG. 2, when an object approaches the display 12, the object sensor 14 detects the operation medium 32. More specifically, the object sensor 14 detects parts of the operation medium 32 for operating the information processing apparatus 10, that is, for example, tips of an index finger and a thumb of the operation medium 32. Since an object inside the space 30 can move, the object detection unit 20 detects positions of parts of an object inside the space 30 at unit time intervals. Here, the unit time intervals are time intervals of, for example, several milliseconds or shorter. The object detection unit 20 transmits a detection signal indicating the positions of the parts of the object to the processor 18.

The input determination unit 22 determines a position A on the display 12 corresponding to a position of a closest one of parts of an object detected by the object detection unit 20 as a command input position based on the user's contact or noncontact operation. The input determination unit 22 compares distances Lv of parts inside the space 30 from the display 12 on the basis of a detection signal from the object sensor 14. The input determination unit 22 then determines, among the parts inside the space 30, a part whose distance Lv is the smallest as a closest part. In the case of a contact operation, the distance Lv of a closest part is zero.

In the example illustrated in FIG. 2, parts 32a and 32b, which are tips of an index finger and a thumb, respectively, of the operation medium 32, are illustrated as representative examples of parts of an object inside the space 30 detected by the object sensor 14. The object detection unit 20 compares a distance Lva between the part 32a and the display 12 in the Zp-axis direction, a distance Lvb between the part 32b and the display 12 in the Zp-axis direction, and a distance Lv between each of parts of other objects inside the space 30 and the display 12 in the Zp-axis direction and, because the distance Lva is the smallest, determines that the part 32a corresponding to the distance Lva as a closest part.

A position A on the display 12 corresponding to a position of a closest part is a point on the display 12 whose Xp coordinate and Yp coordinate are the same as those of a closet part. That is, when a position of a closest part is expressed by coordinates (Xp, Yp, Zp)=(x, y, z) in an XpYpZp space, a command input position is expressed by coordinates (Xp, Yp)=(x, y) on the display 12.

Since an object inside the space 30 can move as described above, the input determination unit 22 determines a closest part and a corresponding position A on the display 12 at the unit time intervals on the basis of a detection signal from the object sensor 14.

The operation determination unit 24 determines details of an operation performed on the information processing apparatus 10 in accordance with a closest part and a corresponding position A on the display 12 determined by the input determination unit 22. Details of an operation refer to any details of the operation such as whether the operation has been performed in a noncontact or contact manner and which operation icon displayed on the display 12 the operation has been performed on.

When an operation icon associated with some type of processing is displayed at a command input position on the display 12 at which a contact operation has been performed, for example, the operation determination unit 24 can determine, by determining the command input position, that a contact operation has been performed on the operation icon. When a gesture operation is possible, the operation determination unit 24 can determine, in accordance with temporal changes in the command input position, that a gesture operation has been performed.

A gesture operation is an operation that can be performed on the basis of the user's movement with an operation medium 32 in contact with the operation surface. A gesture operation refers to an operation based on movement of the operation medium 32, that is, movement of a command input position (movement pattern). That is, by associating movement patterns of a command input position and types of processing with each other in advance, the operation determination unit 24 can detect a movement pattern of a command input position and determine a command in accordance with the detected movement pattern. The processor 18 performs a type of processing associated with an identified gesture.

When an operation for continuously sliding a command input position on the display 12 at which a contact operation was performed has been performed within a certain period of time, for example, it can be determined that an operation for scrolling through the operation screen in a direction of the slide. The operation determination unit 24 may also be capable of determining other gesture operations such as a pinch-in, which reduces an operation screen in accordance with movement of plural command input positions, and a pinch-out, which enlarges an operation screen in accordance with movement of plural command input positions.

In addition, when an operation icon associated with some type of processing is displayed at a command input position on the display 12 on which a noncontact operation has been performed, the operation determination unit 24 can determine, by determining the command input position, that a noncontact operation has been performed on the operation icon. When the distance Lv between the display 12 and the operation medium 32 decreases at a certain speed or higher with a command input position of the operation medium 32 maintained within an area of an operation icon displayed on the display 12, for example, the operation determination unit 24 can determine that a noncontact operation has been performed on the operation icon. The user can thus move the operation medium 32 inside the space 30 without bringing the operation medium 32 into contact with the display 12, in order to move a command input position and input a command based on a gesture.

By associating movement patterns of a command input position and types of processing with each other in advance for noncontact operations, the operation determination unit 24 can detect a movement pattern of a command input position and determine a command in accordance with the detected movement pattern. The processor 18 performs a type of processing associated with an identified gesture.

The operation determination unit 24 also determines a specific noncontact state with respect to the operation surface. The specific noncontact state refers to a state where an object that is not in contact with the display 12 has been detected but a state or a movement that is not valid as an operation for an object displayed on the operation surface has also been detected. The specific noncontact state is established when the user is trying to perform some operation on the information processing apparatus 10 using the operation medium 32 but does not know how to perform the operation.

The specific noncontact state may be, for example, a state where the object sensor 14 has detected an object that is not in contact with the display 12 but a state that is not valid as an operation for an object displayed on the operation surface has been established for a certain reference period of time or longer. The specific noncontact state is, for example, a state where the user has moved the operation medium 32 close to the object sensor 14 in order to perform some operation on the information processing apparatus 10 but, not knowing how to perform the operation, is thinking without moving the operation medium 32. In this case, the operation determination unit 24 determines a state where the user has established a state that is not valid as an operation for the certain reference period of time with the operation medium 32 in proximity to the object sensor 14.

Here, the reference period of time may be appropriately set. The reference period of time may be, for example, fixed at a certain value or different depending on the number, types, functions, or use conditions of objects displayed in the operation screen. For example, the reference period of time set for an operation screen may become longer as the number of objects displayed in the operation screen increases. Alternatively, for example, the reference period of time set for an operation screen may become longer as the types of objects displayed in the operation screen increase. Alternatively, for example, the set reference period of time may be changed in accordance with the functions of objects displayed in the operation screen. Alternatively, for example, the reference period of time set for an operation screen may become longer as use frequencies of objects displayed in the operation screen decreases. The reference period of time may be different between operation screens. For example, the reference period of time may be, for each operation screen, a statistical mean or median of periods of time for which the user maintained a state that was not valid as an operation when the user was confused about an operation.

Alternatively, the specific noncontact state may be, for example, a state where the object sensor 14 has detected an object that is not in contact with the display 12 but a certain pattern of movement that is not valid as an operation for the information processing apparatus 10 has also been detected. For example, the operation determination unit 24 determines, as a specific noncontact state, a state where the user has moved, in order to perform some operation on the information processing apparatus 10, the operation medium 32 close to the object sensor 14 and swept the operation medium 32 across the operation surface or shaken the operation medium 32 over one of operation icons. The certain pattern of movement that is not valid may be determined, for example, on the basis of three-dimensional movement of a position (x, y, z) of a closest part of a detected object or two-dimensional movement of coordinates (x, y) on the display 12.

The guide presentation processing unit 26 performs processing for presenting guide information regarding the information processing apparatus 10. The guide information is not particularly limited insofar as the guide information is information regarding the information processing apparatus 10. The guide information may be an explanation of an operation method used for the operation surface or a function of an object displayed on the operation surface. For example, the guide information may be information regarding an operation performed on the operation surface displayed on the display 12, information regarding an operation for switching from a current operation screen to another operation screen, or information regarding a function of an object displayed on the operation surface. In the present exemplary embodiment, the guide presentation processing unit 26 displays guide information on the screen of the display 12 if the operation determination unit 24 identifies a specific noncontact state. If a certain condition is satisfied, the guide presentation processing unit 26 also performs processing for removing guide information displayed on the display 12.

The information processing unit 28 performs ordinary information processing in the information processing apparatus 10. If the operation determination unit 24 determines that a contact operation has been performed on an operation icon displayed on the display 12, the information processing unit 28 performs a type of information processing associated with the operation icon. If the operation determination unit 24 determines that a contact or noncontact gesture operation has been performed, the information processing unit 28 performs a type of information processing associated with the gesture operation.

Processing performed by the information processing unit 28 is not particularly limited, and may include every type of processing provided by the information processing apparatus 10. When the information processing apparatus 10 is a multifunction device, for example, the information processing unit 28 may perform copying, facsimile, scanning, printing, and the like.

### Process for Presenting Guide in Specific Noncontact State

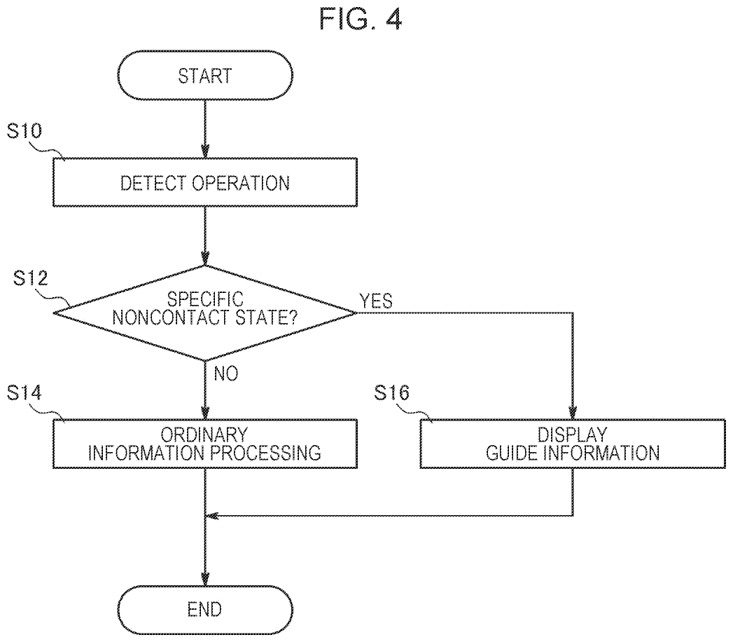

FIG. 4 is a flowchart illustrating a process for presenting a guide in the specific noncontact state according to the present exemplary embodiment. The processor 18 achieves processing in each of steps by executing the program for processing information stored in the memory 16. The process for presenting a guide in the specific noncontact state will be described hereinafter with reference to FIG. 4.

In step S10, a noncontact operation performed on the operation surface is detected. As a result of the processing in this step, the processor 18 functions as the object detection unit 20 and the input determination unit 22. An object inside the space in front of the operation surface is detected on the basis of a detection signal from the object sensor 14. In addition, positions of parts of the object detected by the object detection unit 20 and a position A of a closest part are determined as command input positions.

In step S12, whether the specific noncontact state has been established is determined. As a result of the processing in this step, the processor 18 functions as the operation determination unit 24. If the specific noncontact state has been established, the process proceeds to step S16, and if another contact or noncontact operation has been performed, the process proceeds to step S14.

If the object sensor 14 detected an object that is not in contact with the display 12 but a state that is not valid as an operation for the information processing apparatus 10 has been established for a certain reference period of time or longer, for example, it is determined that the specific noncontact state has been established, and the process proceeds to step S16. In addition, if a movement that is not valid as a gesture operation is detected over a display area of an operation icon with an object not being in contact with the display 12, for example, it is determined that the specific noncontact state has been established, and the process proceeds to step S16. In addition, if a movement that is not valid as a gesture operation is detected all over the operation surface in two dimensions with an object not being in contact with the display 12, for example, it is determined that the specific noncontact state has been established, and the process proceeds to step S16. In addition, if a position (x, y, z) of a closest part of the operation medium 32 has fallen within a certain range in three dimensions in the space 30 in front of the operation surface of the display 12 and a movement that is not valid as a gesture operation has been maintained for a certain reference period of time, for example, it is determined that the specific noncontact state has been established, and the process proceeds to step S16.

In step S14, ordinary information processing based on the contact or noncontact operation performed in step S12 is performed. As a result of the processing in this step, the processor 1u functions as the information processing unit 28. If a contact operation has been performed on an operation icon, for example, a type of information processing associated with the operation icon is performed. If a contact or noncontact gesture operation is performed, for example, a type of processing associated with the gesture operation is performed.

In step S16, processing for displaying guide information based on the specific noncontact state is performed. As a result of the processing in this step, the processor 18 functions as the guide presentation processing unit 26. For example, the processor 18 performs processing for displaying guide information as described hereinafter.

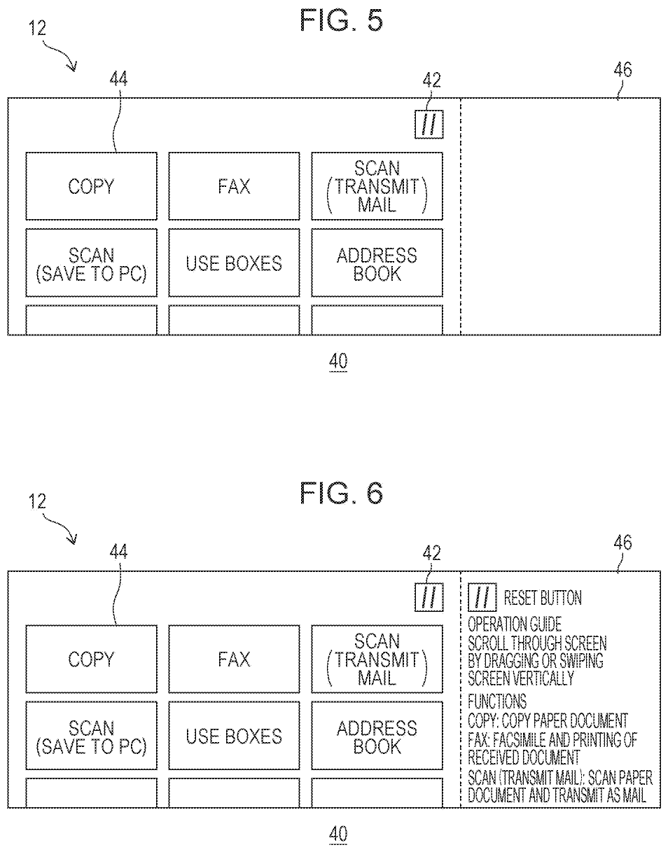

FIG. 5 illustrates an example where a simple menu screen 40 is displayed on the operation surface of the display 12. In the menu screen 40, a reset button 42 and plural operation icons 44 are displayed. The reset button 42 is an icon for requesting processing for resetting an operation performed in the menu screen 40. The operation icons 44 are icons for requesting information processing in the information processing apparatus 10. The operation icons 44 are, for example, icons for performing processing relating to functions such as “copy”, “fax”, “scan (transmit mail)”, “scan (save to PC)”, “use boxes”, and “address book”.

If an object that was not in contact with the display 12 was detected with the menu screen 40 displayed but a state that is not valid as an operation has been established for the certain reference period of time or longer, guide information for explaining operations and functions that can be performed in the displayed menu screen 40 is displayed. As illustrated in FIG. 6, for example, a guide display area 46 is provided for the operation surface of the display 12, and the guide information is displayed in the guide display area 46.

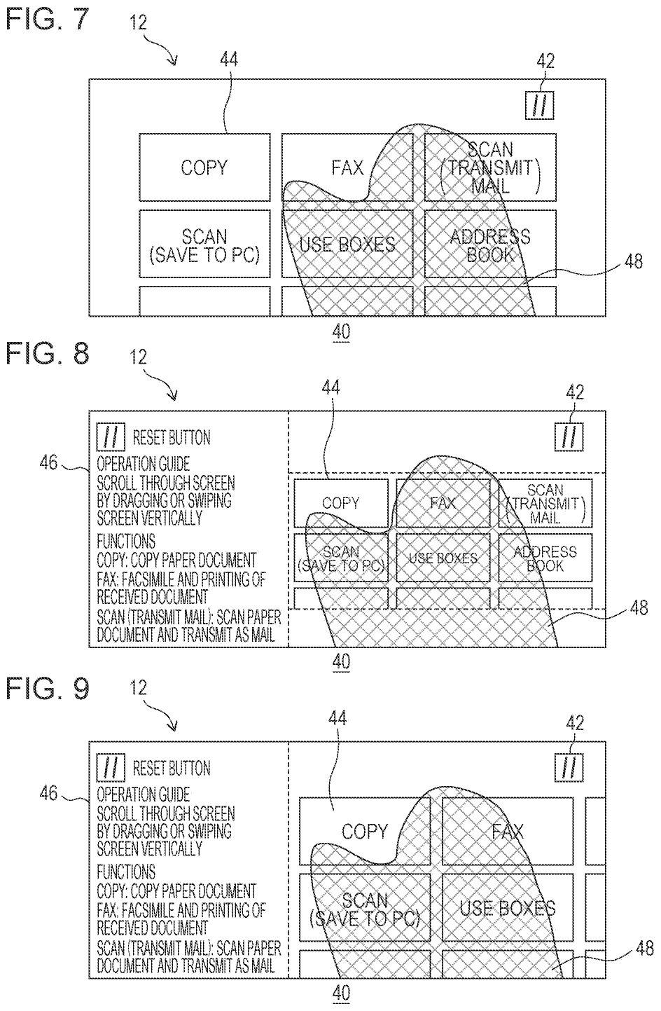

Although the guide display area 46 is provided in advance next to the operation surface and the guide information is displayed in the guide display area 46 in the examples of the menu screen 40 illustrated in FIGS. 5 and 6, an area where the guide information is displayed is not limited to this. The guide information may be displayed outside an area where the object detection unit 20 and the input determination unit 22 have detected an object in proximity to the display 12, instead. If there is a proximity detection area 48, in which an object in proximity to the operation surface of the display 12 has been detected, as illustrated in FIG. 7, for example, the guide information may be displayed while reducing the operation icons 44 and the like and providing the guide display area 46 outside the proximity detection area 48 as illustrated in FIG. 8. Alternatively, as illustrated in FIG. 9, at least subset of the reset button 42 and the operation icons 44 may be slid, and the guide information may be displayed while providing the guide display area 46 outside the proximity detection area 48.

The guide information regarding the menu screen 40 displayed on the display 12 can thus be displayed if it is determined that the specific noncontact state has been established. As a result, the user can understand the operations and the functions that can be performed in the menu screen 40.

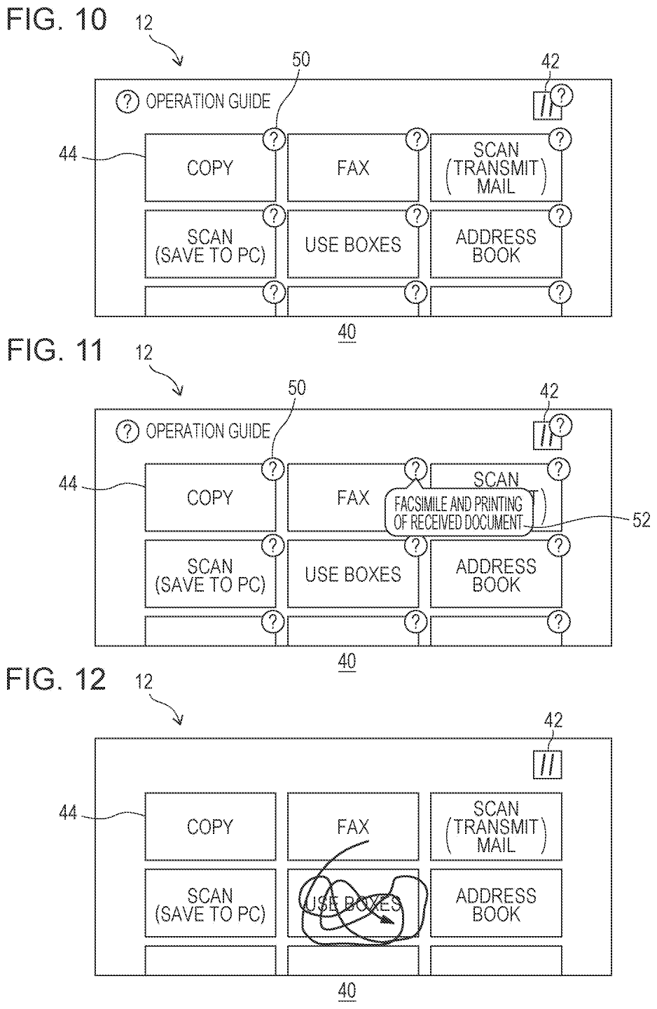

If it is determined that the specific noncontact state has been established, tips about operations and functions that can be performed using the reset button 42 and the operation icons 44 may be displayed as guide information, instead. As illustrated in FIG. 10, for example, tip buttons 50 for displaying the tips about the operations and the functions may be displayed for the reset button 42 and the operation icons 44. By performing a contact click or touch operation or a noncontact gesture operation on one of the tip buttons 50 displayed for the reset button 42 and the operation icons 44 for which the guide information needs to be displayed, guide information regarding a corresponding operation or function is displayed. As illustrated in FIG. 11, for example, a balloon area 52 may be provided in the operation screen, and the guide information regarding the operation or the function may be displayed in the balloon area 52. Alternatively, as in FIG. 6, the guide display area 46 may be provided in advance next to the operation surface, and the guide information may be displayed in the guide display area 46. Alternatively, a mini-icon for displaying the guide information may be displayed.

An operation or a function relating to the reset button 42 or one of the operation icons 44 can thus be displayed if it is determined that the specific noncontact state has been established and the reset button 42 or the operation icon 44 is selected. As a result, the user can understand the operations and the functions that can be performed in the menu screen 40 as necessary.

As indicated by an arrow in FIG. 12, if the operation medium 32 that is not in contact with the display 12 is moving in a way that is not valid as a gesture operation over a display area of one of the operation icons 44, it may be determined that the specific noncontact state has been established, and the process may proceed to step S16. At this time, content of the guide information may be changed in accordance with a trajectory of the detected operation medium 32 in proximity to the operation surface of the display 12.

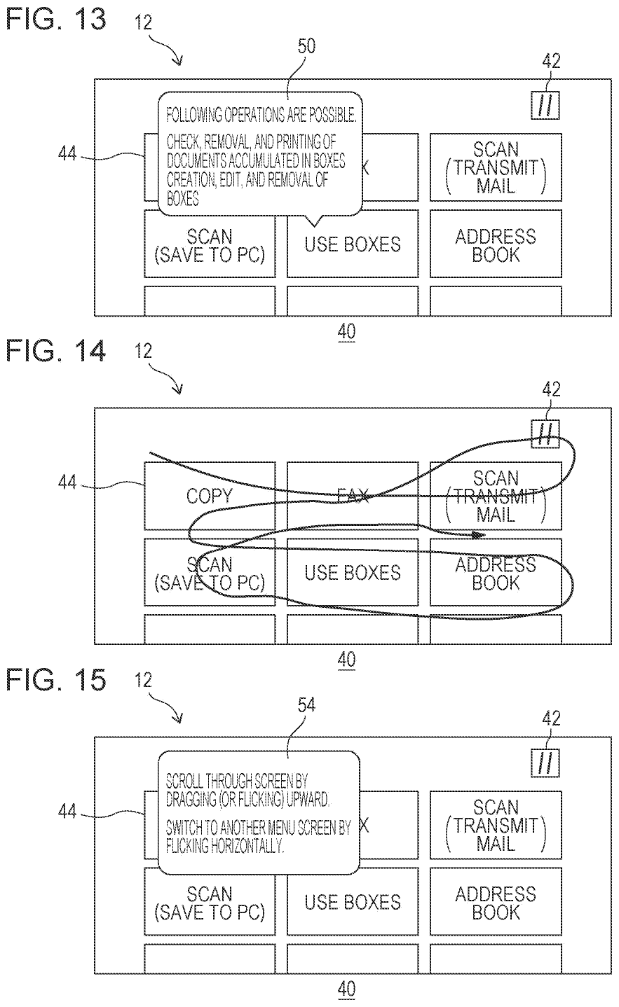

If a reference percentage or more of trajectory length of a two-dimensional position A of a closest part detected for a certain reference period of time is inside a display area of one of the operation icons 44, for example, it may be determined that the specific noncontact state has been established. If 80% or more of trajectory length of a two-dimensional position A of a closest part detected for 10 seconds inside a display area of one of the operation icons 44, for example, it may be determined that the specific noncontact state has been established. If it is determined that the specific noncontact state has been established, guide information regarding the operation icon 44 is displayed. As illustrated in FIG. 13, for example, a balloon area 52 may be displayed for the operation icon 44, and the guide information regarding the operation icon 44 may be displayed in the balloon area 52.

The reference percentage, however, is not limited to 80%, and may be appropriately set. The reference percentage may be different, for example, depending on the number, types, functions, use conditions, or sizes of display areas of objects displayed in the menu screen 40. For example, the reference percentage may become lower as the number of objects displayed in the menu screen 40 increases. Alternatively, for example, the reference percentage may become lower as the types of objects displayed in the menu screen 40 increase. Alternatively, for example, the set reference percentage may be changed in accordance with the functions of objects displayed in the menu screen 40. Alternatively, for example, the reference percentage may become lower as use frequencies of objects displayed in the menu screen 40 decrease. The reference percentage may be different between operation screens.

The reference period of time is not limited to 10 seconds, and may be appropriately set. The reference period of time may be different, for example, depending on the number, types, functions, use conditions, or sizes of display areas of objects displayed in the menu screen 40. For example, the reference period of time may become longer as the number of objects displayed in the menu screen 40 increases. Alternatively, for example, the reference period of time may become longer as the types of objects displayed in the menu screen 40 increase. Alternatively, for example, the set reference period of time may be changed in accordance with the functions of objects displayed in the menu screen 40. Alternatively, for example, the reference period of time may become longer as use frequencies of objects displayed in the menu screen 40 decrease. The reference period of time may be different between operation screens.

As a result, a button, an icon, or the like that the user desires to use and for which he/she is confused about an operation can be identified, and guide information regarding an operation or a function relating to the button, the icon, or the like can be provided. The user, therefore, can precisely understand the guide information regarding the button, the icon, or the like for which he/she is confused about the operation.

Alternatively, as indicated by an arrow in FIG. 14, if the operation medium 32 that is not in contact with the display 12 is moving all over the menu screen 40 in a way that is not valid as a gesture operation, it may be determined that the specific noncontact state has been established, and the process may proceed to step S16. If a percentage of trajectory length of a two-dimensional position A of a closest part detected for a certain reference period of time inside a display area of every operation icon 44 is lower than a reference percentage, for example, it may be determined that the specific noncontact state has been established. If less than 10% of trajectory length of a position A of a closest part detected for 10 seconds is inside every operation icon 44, for example, it may be determined that the specific noncontact state has been established.

The reference percentage, however, is not limited to 10%, and may be appropriately set. The reference percentage may be different, for example, depending on the number, types, functions, use conditions, or sizes of display areas of objects displayed in the menu screen 40. For example, the reference percentage may become lower as the number of objects displayed in the menu screen 40 increases. Alternatively, for example, the reference percentage may become lower as the types of objects displayed in the menu screen 40 increase. Alternatively, for example, the set reference percentage may be changed in accordance with the functions of objects displayed in the menu screen 40. Alternatively, for example, the reference percentage may become lower as use frequencies of objects displayed in the menu screen 40 decrease. The reference percentage may be different between operation screens.

The reference period of time is not limited to 10 seconds, and may be appropriately set. The reference period of time may be different, for example, depending on the number, types, functions, use conditions, or sizes of display areas of objects displayed in the menu screen 40. For example, the reference period of time may become longer as the number of objects displayed in the menu screen 40 increases. Alternatively, for example, the reference period of time may become longer as the types of objects displayed in the menu screen 40 increase. Alternatively, for example, the set reference period of time may be changed in accordance with the functions of objects displayed in the menu screen 40. Alternatively, for example, the reference period of time may become longer as use frequencies of objects displayed in the menu screen 40 decrease. The reference period of time may be different between operation screens.

If it is determined that a specific noncontact operation has been performed in this manner, guide information regarding an operation or a function of the entirety of the menu screen 40 and an operation for switching to another menu screen is displayed. As illustrated in FIG. 15, for example, a balloon area 54 may be provided, and guide information regarding an operation for scrolling through the menu screen 40 and guide information regarding an operation for switching from the menu screen 40 to another menu screen may be displayed.

The guide information can thus be provided for the operation or the function of the entirety of the menu screen 40. The user, therefore, can precisely understand guide information when, for example, he/she does not know how to perform a desired operation or cannot find a desired operation icon 44 on the menu screen 40.

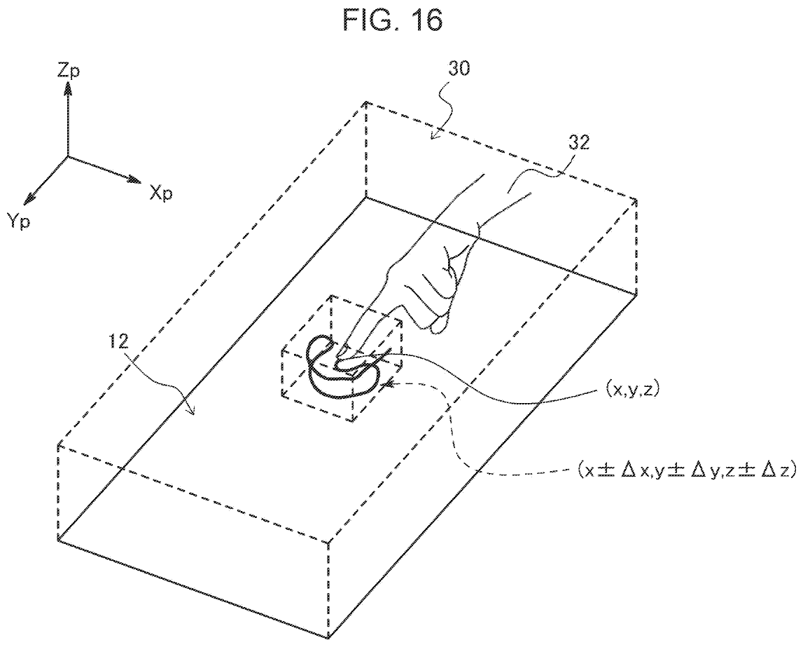

When a noncontact gesture operation is possible, guide information indicating a method for performing the gesture operation may be displayed if it is determined that the specific noncontact state has been established. It is determined that the specific noncontact state has been established, for example, if, as illustrated in FIG. 16, a three-dimensional position (x, y, z) of a closest part of the operation medium 32 has remained inside a certain reference range (x±Δx, y±Δy, z±Δz) in the space 30 in front of the display 12 and a movement that is not valid as a gesture operation has been maintained for a certain reference period of time.

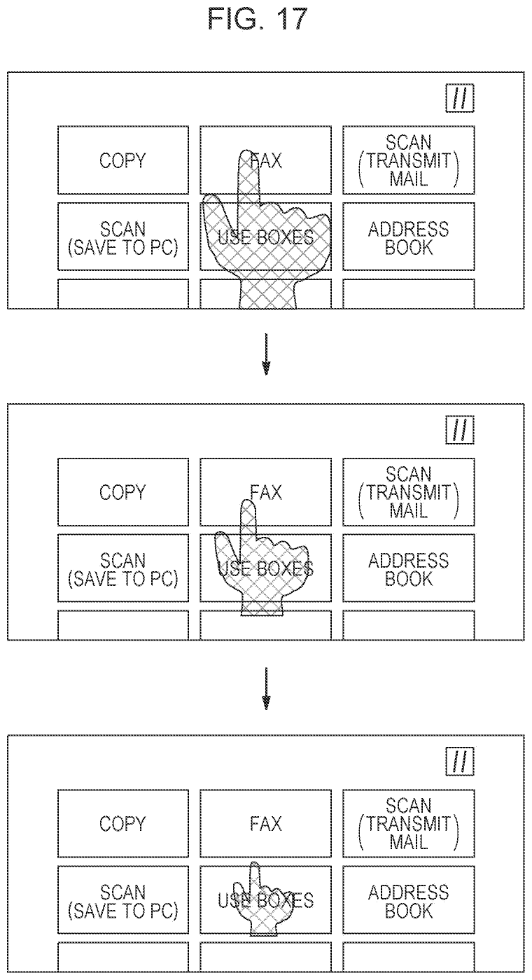

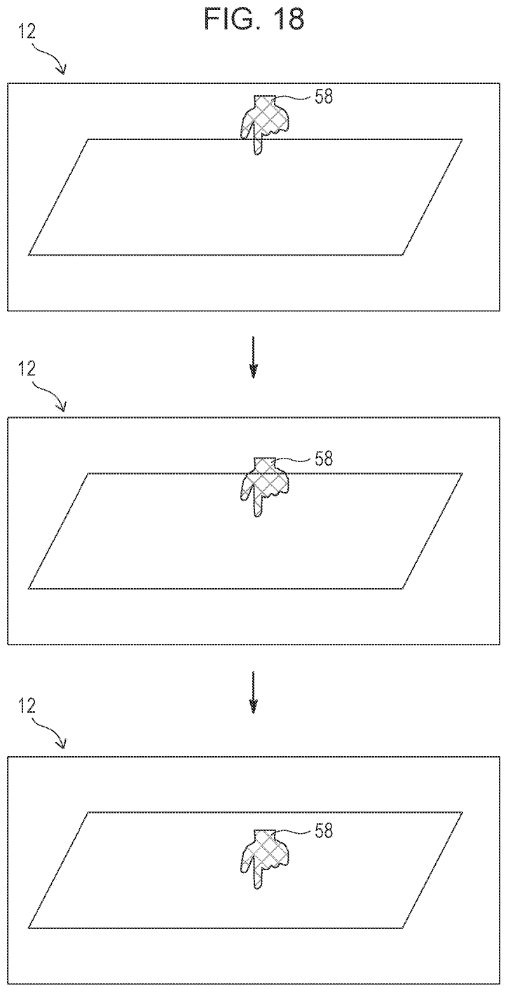

If it is determined that the specific noncontact state has been established, guide information indicating a noncontact gesture operation that can be performed on the menu screen 40 is displayed. When guide information regarding an “air tap”, which is a noncontact gesture operation, is displayed, for example, an animation where a hand image 56, which is an example of the operation medium 32, is repeatedly enlarged and reduced over time is displayed as illustrated in FIG. 17. Alternatively, as illustrated in FIG. 18, the menu screen 40 may be switched to a three-dimensional representation, and an animation where a hand image 58, which is another example of the operation medium 32, approaches the operation surface of the display 12 may be displayed.

When the user is allowed to register gesture operations, methods for performing registered gesture operations may be sequentially displayed one by one. For example, methods for performing gesture operations that can be performed in a menu screen 40 currently displayed on the display 12 may be sequentially displayed one by one.

The reference range (x±Δx, y±Δy, z±Δz), however, may be appropriately set. The reference range may be different, for example, depending on the number, types, functions, use conditions, or sizes of display areas of objects displayed in the menu screen 40. For example, the reference range may become smaller as the number of objects displayed in the menu screen 40 increases. Alternatively, for example, the reference range may become smaller as the types of objects displayed in the menu screen 40 increase. Alternatively, for example, the set reference period of time may be changed in accordance with the functions of objects displayed in the menu screen 40. Alternatively, for example, the reference period of time may become smaller as use frequencies of objects displayed in the menu screen 40 decrease. The reference range may be different between operation screens.

The reference period of time may be appropriately set. The reference period of time may be different, for example, depending on the number, types, functions, use conditions, or sizes of display areas of objects displayed in the menu screen 40. For example, the reference period of time may become longer as the number of objects displayed in the menu screen 40 increases. Alternatively, for example, the reference period of time may become longer as the types of objects displayed in the menu screen 40 increase. Alternatively, for example, the set reference period of time may be changed in accordance with the functions of objects displayed in the menu screen 40. Alternatively, for example, the reference period of time set for the menu screen 40 may become longer as use frequencies of objects displayed in the menu screen 40 decrease. The reference period of time may be different between operation screens.

A mode in which guide information is presented is not limited to the above example, and any mode may be employed insofar as the user can understand guide information. For example, guide information may be presented as not visual information but audio information such as sound or tactile information such as vibration, instead.

Presentation of guide information may be stopped in accordance with a certain condition. Presentation of guide information may be stopped, for example, if a contact operation is performed or a valid noncontact operation is performed on the operation surface. Alternatively, for example, presentation of guide information may be stopped if the specific noncontact state is resolved or the object sensor 14 no longer detects an object.

Although an exemplary embodiment of the present disclosure has been described, the present disclosure is not limited to the above exemplary embodiment and may be modified in various ways without deviating from the scope of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))
   An information processing apparatus comprising:
      a processor configured to:
         detect a specific noncontact state established by a user for an operation surface; and
         present, if the specific contact state is detected, an explanation of an operation method used for the operation surface or a function of an object displayed on the operation surface.
(((2)))
   The information processing apparatus according to (((1))),
   wherein the specific noncontact state is a state where proximity to the operation surface has been detected for a certain period of time but an operation has not been performed on the object displayed on the operation surface.
(((3)))
   The information processing apparatus according to (((1))) or (((2))),
   wherein the explanation differs depending on a trajectory of detection of the proximity to the operation surface.
(((4)))
   The information processing apparatus according to any one of (((1))) to (((3))),
   wherein the explanation of the operation method is an explanation of a method for performing a gesture operation based on a movement of the user with respect to the operation surface.
(((5)))
   The information processing apparatus according to (((4))),
   wherein the explanation of the operation method is an explanation of a method for performing a gesture operation based on a movement of the user performed without contact with the operation surface.
(((6)))
   The information processing apparatus according to any one of (((1))) to (((5))),
   wherein the explanation is displayed outside an area where proximity to the operation surface has been detected.
(((7)))
   A program causing a computer to execute a process for processing information, the process comprising:
   detecting a specific noncontact state established by a user for an operation surface; and
   presenting, if the specific contact state is detected, an explanation of an operation method used for the operation surface or a function of an object displayed on the operation surface.

What is claimed is:

1. An information processing apparatus comprising:
a processor configured to:
detect a specific noncontact state established by a user for an operation surface; and
present, if the specific contact state is detected, an explanation of an operation method used for the operation surface or a function of an object displayed on the operation surface.

2. The information processing apparatus according to claim 1,
wherein the specific noncontact state is a state where proximity to the operation surface has been detected for a certain period of time but an operation has not been performed on the object displayed on the operation surface.

3. The information processing apparatus according to claim 1,
wherein the explanation differs depending on a trajectory of detection of the proximity to the operation surface.

4. The information processing apparatus according to claim 1,
wherein the explanation of the operation method is an explanation of a method for performing a gesture operation based on a movement of the user with respect to the operation surface.

5. The information processing apparatus according to claim 4,
wherein the explanation of the operation method is an explanation of a method for performing a gesture operation based on a movement of the user performed without contact with the operation surface.

6. The information processing apparatus according to claim 1,
wherein the explanation is displayed outside an area where proximity to the operation surface has been detected.

7. The information processing apparatus according to claim 2,
wherein the explanation is displayed outside an area where proximity to the operation surface has been detected.

8. The information processing apparatus according to claim 3,
wherein the explanation is displayed outside an area where proximity to the operation surface has been detected.

9. The information processing apparatus according to claim 4,
wherein the explanation is displayed outside an area where proximity to the operation surface has been detected.

10. The information processing apparatus according to claim 5,
wherein the explanation is displayed outside an area where proximity to the operation surface has been detected.

11. A non-transitory computer readable medium storing a program causing a computer to execute a process for processing information, the process comprising:
detecting a specific noncontact state established by a user for an operation surface; and
presenting, if the specific contact state is detected, an explanation of an operation method used for the operation surface or a function of an object displayed on the operation surface.

12. A method for processing information, the method comprising:
detecting a specific noncontact state established by a user for an operation surface; and
presenting, if the specific contact state is detected, an explanation of an operation method used for the operation surface or a function of an object displayed on the operation surface.
